(19) United States
(12) Patent Application Publication
(10) Pub. No.: US 2005/0019722 A1
(43) Pub. Date: Jan. 27, 2005

(54) Medical or dental rod-like handpiece having a display

(76) Inventors: Gerhard Schmid, Mittelbiberach (DE); Franz Liebhardt, Ochsenhausen (DE); Gerd Lohn, Biberach-Rissegg (DE); Hubert Mosslang, Oberdischingen (DE)

Correspondence Address: MARSHALL, GERSTEIN & BORUN LLP, 6300 SEARS TOWER, 233 S. WACKER DRIVE, CHICAGO, IL, 60606, US

(21) Appl. No.: 10/643,693

(22) Filed: Aug. 19, 2003

(30) Foreign Application Priority Data
Aug. 22, 2002 (DE) 102 38 556.4

(51) Int. Cl. A61C 3/00

(52) U.S. Cl. 433/29

(57) ABSTRACT

The invention relates to a medical or dental handpiece. In order to improve the operability of the handpiece and/or the practicability of the treatment, and in particular to simplify that, the handpiece has a display for the showing of a work-relevant data of images.

The invention relates to a medical or dental rod-like handpiece in accordance with the preamble of claim 1.

It is the purpose of such a handpiece to act directly or indirectly on a treatment site on the human or animal body with a functional element arranged in the forward end region of the rod-like handpiece. In order to hinder as little as possible a visual observation by the person effecting the treatment of the treatment site and/or of the functional element, the functional element is arranged in the forward end region of an elongate neck section, from which a grip section extends rearwardly, which grip section serves for the manual grasping of the handpiece. Moreover this configuration makes it possible to reach a treatment site in a body orifice, such as is the case in the mouth of the patient with a dental handpiece, whereby the length of the neck section is adapted to the depth or desired depth of the body orifice, or may be longer.

In the case of the above-described construction of the handpiece there is involved a conventional construction which is described for example in DE 297 20 616 U1 and in DE 100 43 749 A1.

With a handpiece of the kind concerned here there is furthermore involved an object with which the body can be acted upon with different functional features, which can be predetermined by the operating person or also may be changed during the treatment, for example the speed of rotation of a rotary tool. The person carrying out the treatment has therefore to direct their attention not only to the treatment but also to the functional setting of the handpiece, which can have a significant effect on the treatment.

In the specialist field involved here, there have been introduced specific designations for kinds of handpiece which differ in terms of construction and/or function. One distinguishes between working handpieces, which serve to act upon the body, for example to remove material, by means of a tool, which in particular may be moveable, and so-called functional handpieces which serve to deliver or remove auxiliary media to the treatment site, for example water, air or a water-air mixture, or light, and probe handpieces which serve to probe a treatment site for example with regard to its constitution, whereby there may be involved a handpiece with an image-taking device with which images of the treatment site can be taken and reproduced, for example on a screen associated with the treatment chair or the treatment station.

Thus, the object of the invention is, with a handpiece of the kind indicated in the introduction, to improve, and in particular to simplify, the operability of the handpiece and/or the practicability of the treatment.

The handpiece is to be so configured that the attention required of the person carrying out the treatment for monitoring the function of the handpiece can be reduced, and thus the person carrying out the treatment can direct his attention to the treatment of the body to an increased degree.

This object is achieved means of the features of claim 1. Advantageous further developments of the invention are indicated in the subclaims.

In the case of the configuration according to the invention a display is arranged on the handpiece, on which display there can be shown functional features or work relevant items of data of the handpiece and/or images of the treatment site. Here there may be involved one or more items of data which are presently in operation, and/or settable items of data.

Through this, the attention to be directed to the functioning of the handpiece by the person carrying out the treatment is substantially reduced, because the person carrying out the treatment can recognize and check on the display the functional features which are in presently in operation or which can be set, and can therefore direct his attention to the treatment of the body to an increased degree.

In the case of a working handpiece, the at least one functional feature which can be shown on the display may be for example the working speed, in particular the speed of rotation, of a working tool. In the case of a functional handpiece, the at least one functional feature which can be shown on the display may be the settable or set kind of a treatment medium, for example air, water or spray. The person carrying out the treatment does not need to memorize this information. He can thus direct his attention to an increased degree to the treatment of the body. In order to set or check a functional feature, which functional feature is in operation, the person carrying out the treatment needs only to glance at the display, through which he receives the information he desires in an ergonomically favourable manner.

The configuration in accordance with the invention is suitable also for a probe handpiece or a for a combined working/probe handpiece or a combined functional/probe handpiece having an image-taking device arranged in the forward region of the neck section, the images from which can be shown on the display. Through this, the person carrying out the treatment obtains a direct view of the treatment site, or the images taken, on the display. This applies also for such treatment sites which to date could only be viewed by means of mirrors, which for the person carrying out the treatment is stressful and ergonomically complicated, whereby also considerable restriction of the view of the treatment site is to be expected.

Although it is already known from DE 40 09 438 A1 to show on a display images taken by an image-taking device on a handpiece, with the state of the art the display is however associated with a treatment chair in the region of a control desk. With this previously known configuration, the person carrying out the treatment must effect relatively great movements with the head or with his body in order to direct his view to the display. Here, there arises the danger that if the hand instrument remains at the treatment site, the person carrying out the treatment can no longer check and/or position the hand instrument and the handpiece unintentionally moves, through which incorrect handpiece movements could be carried out and possibly even injuries could be caused to the body in the region the treatment site. In contrast, the configuration in accordance with the invention makes it possible manually to check the handpiece with a glance at the display, through which not only are the above-described difficulties avoided, but also a more simple and precise guiding of the handpiece is possible.

An advantageous location for arrangement of the display is found in the region between the grip section and the neck section. Here, the handpiece may be formed straight or also curved in an arc or angled, whereby the neck section may be bent off or angled to the side with an acute angle.

A functional handpiece is, for carrying out a function at the treatment site, so manually gripped by the person carrying out the treatment that the angle included between the neck section, for example bent or angled to the side, and the middle axis of the grip section is open towards the side away to the person carrying out the treatment, that is, the neck section, for example formed to be convergent towards its free end, is thereby directed in the direction away from the person carrying out the treatment. It is thus advantageous to arrange the display on the side of the handpiece which is opposite to the bending out or angling. In this region the person carrying out the treatment has a direct or favourable view of the display so that he can clearly read the imaged work-relevant information.

In contrast, with a working handpiece which is bent or angled to the side, the forward limb which bent or angled to the side and is comparable to the neck section, is angled or bent to the side away from an insertion opening for a tool at the head of the handpiece. With such a handpiece it is therefore advantageous to arrange the display in the region of the free space of the handpiece which is bounded by an obtuse angle between handpiece sections (grip section, limb section or neck section) enclosing it, in particular in the region of the apex of the angling or in the transition region between the straight and the curved handpiece section. Here, the display may be, with regard to the plane of the angling, arranged offset in a peripheral direction, because in this position the person carrying out the treatment has a still better direct view of the display. However, with such a configuration there arise different handpieces for right-handed and left-handed persons. In this respect it is therefore advantageous to arrange the display in the plane of the angling or curvature. Further features of configuration of the invention contribute to improving the direct view of the display and to achieving a simple and economical production.

The configuration in accordance with the invention having the display is advantageous in particular in combination with an image-taking device which is arranged in the forward end region of the handpiece, and the images from which can be shown on the display. With this configuration the images taken of the treatment site can be read, whilst maintaining the above-described advantages, readily and ergonomically favourably.

The image-taking device in accordance with the invention according to claim 11 and following is suitable however not only in combination with a display arranged on the handpiece in accordance with any of claims 1 to 10, but the image-taking device is suitable also in combination with a display that is arranged in the region of a supply device for the handpiece, with which the handpiece is connected by means of a flexible supply line, or the image-taking device is suitable also in combination with a display which is arranged in the region of the treatment station viewable by the person carrying out the treatment.

Since a handpiece of the kind concerned here is on the one hand of compact construction and on the other hand is arranged moveably, and thus restricted space is available, a wireless transfer of the data to be shown on the display of the handpiece is very advantageous. In the case of work-relevant images which are to be shown on the display there are associated with an image-taking device in the forward end region of the handpiece a converter device for converting the images into transferable data, and a data transmitter which makes it possible to transfer the image data wirelessly to a data receiver of the handpiece. The transferred data is so converted by means of a second data conversion device that it can be represented as images on the display.

In the case of the showing of work-relevant data on the display of the handpiece, there are transferred to the data receiver, wirelessly, work-relevant data items, for example from a data transmitter of the supply device of the associated treatment chair, which are converted by the data conversion device to work-relevant data which can be shown on the display.

Below, advantageous configurations of the invention will be explained in more detail with reference to a plurality of exemplary embodiments and to the drawings. There is shown:

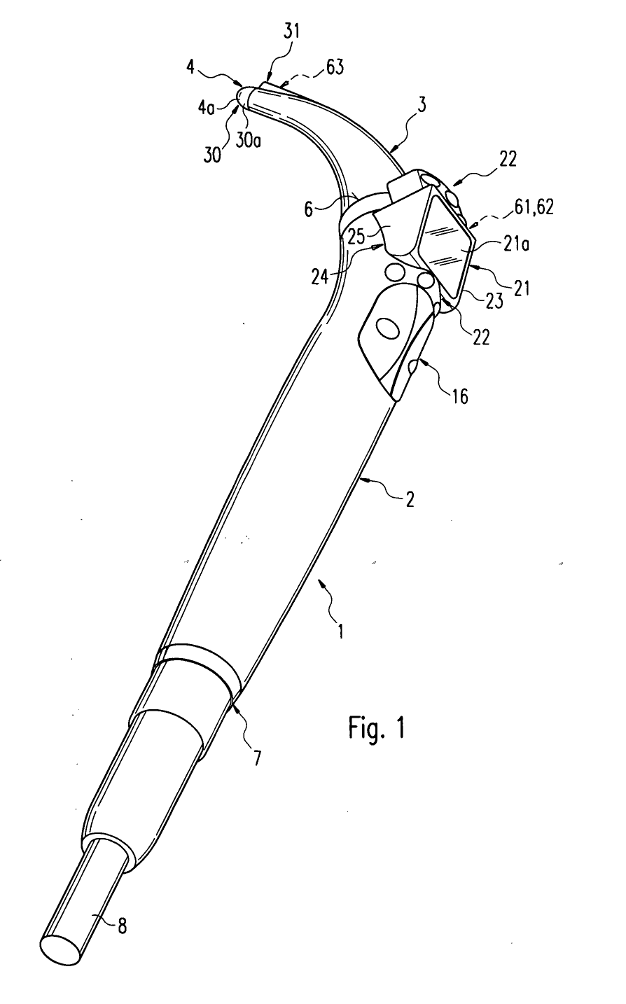

FIG. 1 a handpiece in accordance with the invention, in a perspective illustration;

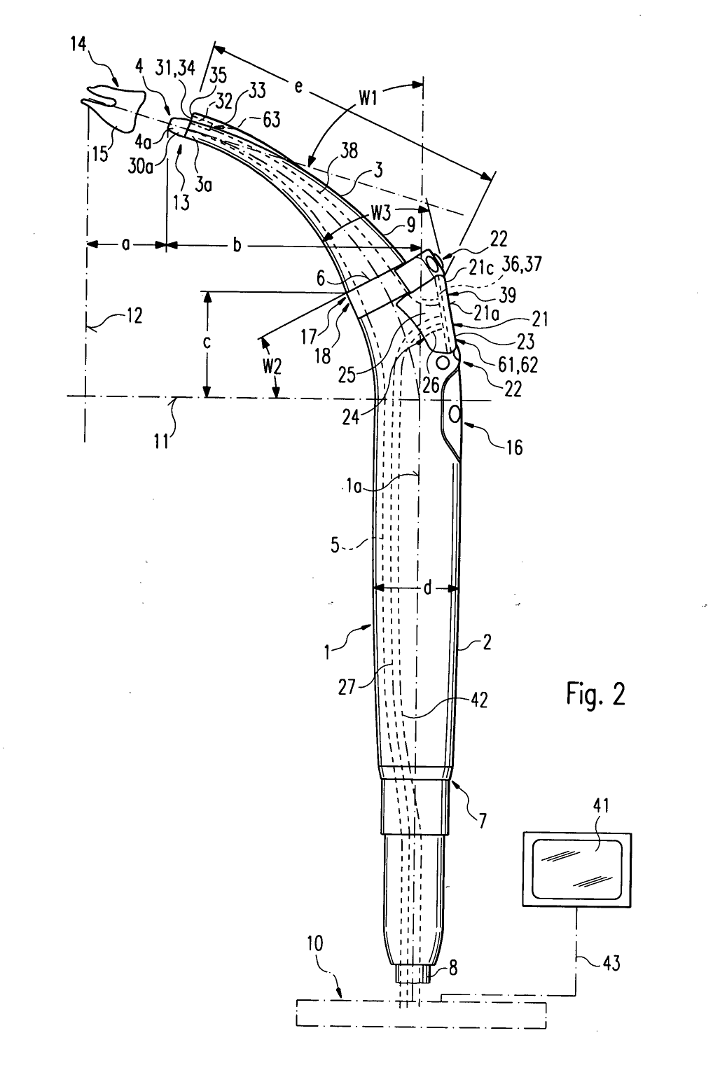

FIG. 2 the handpiece in a side view;

FIG. 3 a handpiece in a modified configuration, in a side view;

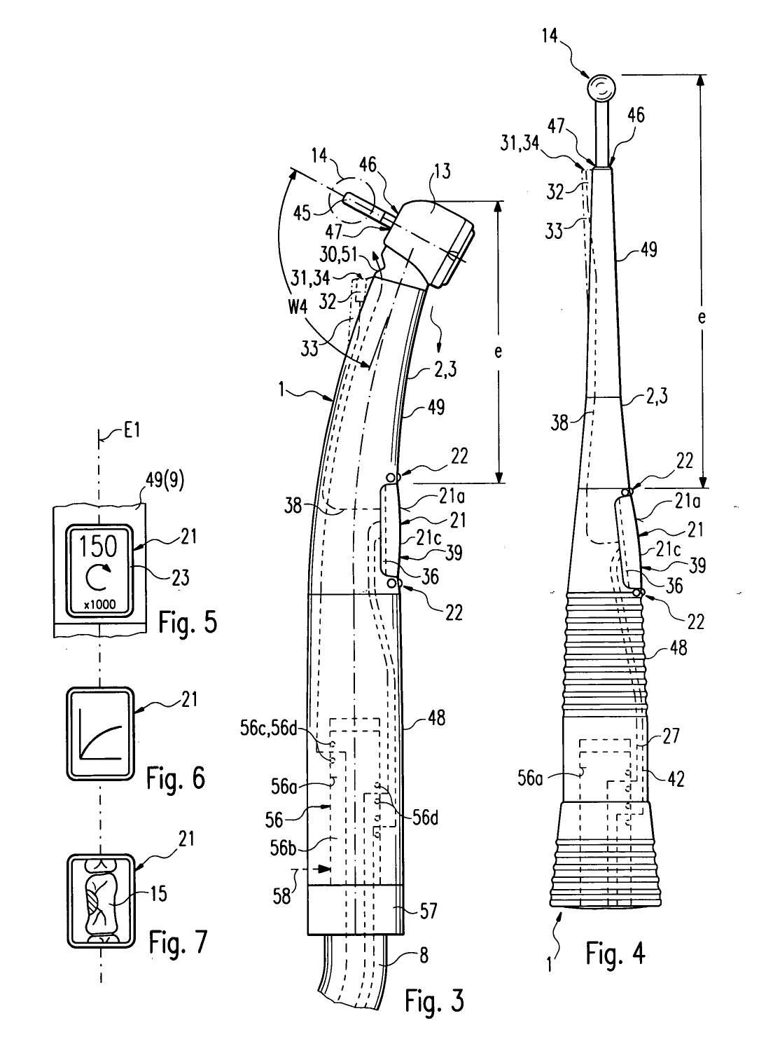

FIG. 4 a handpiece in a further modified configuration, in a side view;

FIGS. 5 to 7 views from above of a handpiece display showing different items of data or images.

The handpiece, designated in its entirety by 1, is according to FIGS. 1 and 2 a so-called functional handpiece for the delivery of one or more treatment media, for example water, air or spray and/or light. The handpiece 1 is of elongate rod-like structure and it has a rod-like grip section 2 from which there extends forwardly a neck section 3 which has in its forward end region a functional element 4 for the direct or indirect treatment of the human or animal body, for example in the present case an outlet nozzle 4a for one or more treatment media, which are supplied to the outlet nozzle 4a through one or more delivery lines 5, which extend longitudinally through the handpiece 1 and of which one delivery line 5 is illustrated by way of example. For this purpose, the grip section 2 and the neck section 3 are formed sleeve-like so that there is located therein free space for passage.

The grip section 2 and the neck section 3 may be formed in one piece or be formed with a joint 6 in two pieces and connectable with one another, whereby they may be releasably or non-releasably connected with one another. The neck section 3 preferably forms a cannula.

On the rearward end of the grip section 2 there is formed, for example in one piece, a connection part 7 which serves to connect the handpiece 1 with a flexible supply hose 8 which extends from a schematically illustrated supply device 10 and serves for the functional control of the handpiece 1. The connection part 7 may be for example a connection pipe piece with which the supply hose 8 is connected, for example by means of a screw connection.

The handpiece 1 is curved or angled to the side in its forward end region. The beginning of the preferably circular arc shaped curvature 9 has preferably the form approximately of a quarter circle. The beginning of the curvature is designated by means of a radial line 11 which at the same time represents the beginning of a quadrant in which the curvature 9 develops. The other radial line bounding the quadrant runs approximately parallel to the middle axis 1a of the handpiece 1 in the region of the grip section 2. As can be clearly understood in particular from FIG. 2, the head 13 of the handpiece 1 ends before the second radial line 12, whereby this spacing a is preferably about 5 mm to 30 mm, in particular about 15 mm. Here, the longitudinal middle axis 1a in the region of the head 13 may have with the imaginary, straight extending middle axis 1a in the region of the grip section 2, a forwardly open acute angle W1 of about 70° to 90°, in particular about 80° to 85°.

The lateral spacing b, which the head 13 has from the imaginary extension of the straight longitudinal middle axis 1a of the grip section 2, may be about 30 to 60 mm, in particular about 45 mm.

In order in operation of the handpiece 1 to adversely effect as little as possible the view of the person carrying out the treatment of the treatment site 14, which by way of example is indicated by means of a tooth 15, one strives to form the cross-sectional size of the head 13 as small as possible. In the case of the exemplary embodiment, the neck section 3 thus tapers forwardly, preferably continuously, whereby the cross-sectional size of the outlet nozzle 4a, for example attached by means of screwing in or screwing on, may correspond in substance to the cross-sectional size of the neck section end 3a. In the case of the exemplary embodiment the handpiece 1 is round, in particular circular, in the region of the grip section 2 and in the region of the neck section 3. The material of the grip section 2 and of the neck section 3, which are in substance formed sleeve-like, may be of corrosion resistant metal, for example alloy steel, or plastics.

The handpiece 1 has, at an actuation location which can be readily reached, one or more actuating elements 16 through the actuation of which it is possible to change functional features of the handpiece 1, for example switch them on and off, here for example the switching on and switching off of at least one treatment media.

The actuating element or elements 16 are arranged in substance on the surface of the handpiece 1 on the side of the handpiece 1 away from the side offset of the head 13 and are formed for example by means of at least one push button. The actuating element or elements 16 pass through the jacket of the handpiece 1 or grip section 2 and may stand for example in drive connection with at least one valve in the delivery line or lines 5.

With the exemplary embodiment, the dividing joint 6 is located at a forwardly offset spacing c from the apex of the angling or from the beginning of the curvature 9. The angle W2, between the radial line 11 and the dividing joint 6 preferably extending at right angles to the longitudinal middle axis 1a, may be about 45°, preferably about 30°. The mechanical connection 17 between the grip section 2 and the neck section 3 is preferably a plug-in connection, in particular a plug-in connection combined with a latching device 18. Such a connection 17 can be made or released without a relative movement of the parts with respect to one another, in particular only in a workshop, so that the person carrying out the treatment is not in a position to release the connection 17 with the means normally available in the practice. Through this, incorrect handling of the handpiece 1 is intended to be avoided.

A display 21 is arranged on the handpiece 1, on which display work-relevant data or images of the handpiece or of the treatment site 14 can be shown, and which is arranged on the surface of the handpiece 1 or in a position raised somewhat therefrom. The display area 21a is preferably flat or slightly curved and it represents in the case of a handpiece which is approximately round in cross-section a tangent or line which with regard to the surface 9 of the handpiece may have an outwardly directed radial spacing. The width of the display 21 or its area 21a corresponds approximately to the cross-sectional size d of the handpiece 1 in the region in which the display 21 is arranged.

An advantageous position for arrangement for the display 21 is in the forward region of the grip section 2, so that the display 21 has a spacing e from the head 13, which ensures the accessability to the treatment site 14 and in a body orifice, for example in the mouth of a patient, whereby the spacing e is the same or greater than the body orifice depth, so that in the treatment disposition of the handpiece 1, the display 21 is located outside the body orifice. In the case of the exemplary embodiment, the forward region of the grip section 2 in the regions of the spacing c is already curved, in the sense of a bend, whereby the display 21 is arranged in this bend region.

In order to take account of both right-handed and left-handed persons with one and the same configuration, it is advantageous to arrange the display 21 symmetrically with regard to the longitudinal plane E1 containing the angling or curvature of the handpiece 1, as the exemplary embodiment shows.

There is associated with the display 21 at least one manually accessible actuating element 22, preferably on the handpiece 1, in order for example to switch on and switch off the display 21 and/or to select in particular one of a plurality of available display read-outs. A preferred arrangement position for the actuating element or elements 22 is the edge region of the display 21. In the case of the exemplary embodiment, one or more actuating elements 22 are arranged directly behind and/or directly before the display 21, preferably in each case in a transverse row, for example each of three elements. The form of the display area 21a is preferably rectangular, for example quadratic, and if applicable with rounded corners or overall round. Insofar as further actuating elements should be associated with the display 21 which find no space behind or at the rearward edge, one or more actuating elements 22 can also be arranged at the forward edge of the display 21 or before this, as the exemplary embodiment likewise shows. Also with this configuration, a handpiece 1 is suitable, at least as a prefabricated component, both for right-handed and also left-handed configurations.

The display 21 has a plate-like cover body 21c, which is held in a frame-like fitting 23 and can be mounted and dismounted from the outside. The fitting 23 is formed on a base 24 which may have three or four side walls 25, forming a frame, standing up from the surface 9 of the handpiece 1, in the free edge regions of which side walls the fitting 23 maybe arranged. In the hollow space bounded by the side walls 25 there is arranged a line passage 26 for at least one line for the delivery of energy or of control or functional signals of the handpiece 1. The at least one line 27 may extend from the rear longitudinally through the handpiece 1, for example from the control apparatus 10 through the supply hose 8.

The display 21 may include an acute angle W3 with the middle axis 1a, which angle is forwardly open. If the display 21 is arranged in the region of the curvature 9 (FIG. 1) the angle W3 is smaller than the angle W1, whereby it may be about half that angle.

The display 21 is suited very advantageously in combination with an image-taking device 31 for the taking of images of the treatment site, whereby the images can be shown on the display 21. Hereby, at least one functionally relevant feature of the handpiece, for example the speed of rotation effective in each case, can still be shown on the display 21, for example in its edge region, where it does not disrupt the image representation.

In the case of the exemplary embodiment, the image-taking device 31 is arranged in the forward end region of the handpiece 1, whereby it may be arranged on the neck section 3, for example in a position laterally offset with regard to the middle axis 1a. In the case of the exemplary embodiment, the image-taking device 31 is arranged in the plane of angling or curvature E1 and for example with regard to the neck section 3 arranged forwardly offset, for example as an image-taking module 32 in a material annex 33 which may extend rearwardly for example in the shape of a bulge and can run out into the neck region 3 in the region of the neck section 3 of greater thickness.

The image-taking device 31 has a light entry opening 34 which is covered by means of a light permeable closure plate 35 in particular of glass or plastics. Behind the closure plate there is arranged an image converter device 36 which converts the image taken into electronic data. This data is passed to an image reproduction device 37 of which the display 21 is a part, and which visibly reproduces the data on the display 21 in each case as an image.

It is possible to associate the image conversion device 36 with the image reproduction device 37 and to direct the images taken to the image conversion device 36 through a light conductor 38 extending longitudinally through the neck section 3 and in the grip section 2, and through the line passage 26. It is also possible to associate the image converter device 36 with the image-taking device 31 and to supply the electronic data of the images taken through a signal or data line, replacing the light conductor 38, to the image reproduction device 37.

There is associated with the image reproduction device 37 an electronic control device 39 which makes it possible to switch on various image reproduction functions, for example a still image and/or a screen 41 which is arranged in the region of an associated treatment chair and is connected by means of a data line 42, 43 through the supply device 10 with the image reproduction device 37. For the switching on of these control processes there may be provided one or more of the described actuating elements 22.

There is associated with the handpiece 1 preferably an illumination device 30 for the illumination of the treatment site 14, which has a light emission element 30a arranged in the forward end region of the handpiece 1 or of the cannula, which light emission element may be formed by means of the nozzle body 4 and is of light permeable material, for example of plastics or glass, and to which the light is supplied from the rear, for example through a light conductor extending longitudinally in the handpiece 1 or neck section 3. The light emission element 30a is preferably releasably connected by means of a plug-in connection or quick release connection on the handpiece 1 or neck section 3, and in particular exchangeable with a substitute element. The light emission element 30a forms a forward longitudinal section of the handpiece 1 or neck section and is suitable to spatially illuminate a treatment site 14.

The exemplary embodiment according to FIG. 3, in which the same or similar parts are provided with the same reference signs, shows a handpiece 1 in the form of a working handpiece having a tool 45 which can act upon the body, here a drill or milling tool, which is releasably held in a holder device 46 arranged in the head 13, which holder device has a lateral insertion opening 47 for the tool 45. This handpiece is curved or angled towards the side away from the insertion opening 47, for example in its forward half, as is per se known. With such a handpiece 1, the display is arranged on the side of the handpiece 1 which is away from the insertion opening 47, whereby the display 21 likewise has the spacing e from the forward end of the handpiece 1 and is preferably arranged in the middle longitudinal region of the handpiece 1, for example in the transition region between a straight rearward handpiece section 48 and the forward handpiece section 49 which in the case of the present exemplary embodiment is curved or may also be angled in the manner described above, forwardly continuously tapers in its cross-section and forms a grip section.

Also with the exemplary embodiment according to FIG. 3 there may be arranged in the forward end region of the forward handpiece section 49 an image-taking device 31 which here is preferably arranged on the side of the handpiece section 49 towards the insertion opening 47 and can be integrated in a material annex 33, for example placed therein as an image-taking module. In this position there is provided, due to the triangular free space between the tool 45 and the handpiece 1, a favourable position of the image-taking device 31 with regard to the treatment site 14. The image-taking device 31 may be arranged before or preferably behind a schematically indicated media outlet opening 51 for water, air or spray and/or a light exit opening of the illumination device 30.

In the case of the exemplary embodiment, the display 21 is arranged in the rearward end region of the curved or angled handpiece section 49.

The angle W4 between the longitudinal middle axis 1a and the middle axis of the tool 45, and the handpiece middle axis 1a intersecting it, is obtuse and preferably about 95 to 102°, in particular about 100°. This form is particularly favourably adapted to the jaw shape of the human bite and thus this form is suited in particular for a dental-medical handpiece 1. On the other hand, this form affords a space-favourable arrangement between the tool 45 and the image-taking device 31 with a relatively great spacing between these parts. The cross-sectional size of the preferably round handpiece section 49 diminishes forwardly, preferably continuously, through which the view of the person carrying out the treatment of the treatment site is improved.

Between the image-taking device 31 and the insertion opening 47 there may be provided at least one outlet opening 51 for a media outlet such as air or water or spray or light, whereby the at least one schematically illustrated media line 5 extends to this outlet opening 51.

Otherwise this exemplary embodiment is, with regard to the signal or data and/or image processing, constituted corresponding to the exemplary embodiment according to FIGS. 1 and 2, so that for the avoidance of repetition reference can be made thereto and a repeated description of these features is not necessary.

The latter applies also for the exemplary embodiment according to FIG. 4, in which likewise the same or similar parts are provided with the same reference signs. The handpiece 1 of this exemplary embodiment is likewise a working handpiece, namely a so-called surgical handpiece, which extends straight and has the insertion opening 47 for the tool 45 at its forward end, not to the side but at the end face, so that the tool 45 extends forwardly. Also with this exemplary embodiment, a rearward, straight extending section of the handpiece 1 may form a grip section 2 from which a neck section 3 extends forwardly, preferably continuously tapering. It is also possible to use the neck section 3 as a grip section during a treatment.

Also with this exemplary embodiment, the display 21 has a spacing e from the forward end of the handpiece 1. There can also be associated with the display 21 an image-taking device 31 which is integrated into the forward end region of the handpiece, for example in a lateral material annex 33, as has been described above. Thereby it can be advantageous, depending on the use, to arrange the image-taking device 31 on the side of the handpiece 1 opposite to the display 21, through which there is provided a favourable image-taking position for the image-taking device 31 in the treatment position of the handpiece 1.

Further, it is possible and advantageous to form the handpiece 1 in each case with a coupling element at the rear side, which matches a plug-in/turn coupling 56 for the releasable connection of the handpiece 1 with a connection part 57 (FIGS. 3 and 4). The supply line 8 is connected with the connection part 57. The plug-in/turn coupling 56 has preferably a hollow cylindrical plug-in recess 56a into which a matching plug-in pin 56b can be inserted. For securing the handpiece in the coupling position there is associated with the plug-in/turn coupling 56 a latching device 58 which can be overcome manually and which upon coupling or plugging together self-actingly elastically latches in and upon separation of the coupling 56 is overcome and self-actingly latches out.

In the cases in which the handpiece 1 has at least one media line 5, this passes through the plug-in/turn coupling 56 in a Z-form, whereby in the region of the radial passage of the media line 5 through the hollow cylindrical dividing joint of the coupling 56 there is arranged an annular groove 56c in the plug-in pin 56b or in the plug-in recess 56a, and this radial passage is sealed off on both sides in each case by means of a sealing ring 56d which sits in an annular groove of the plug-in pin or of the plug-in recess, as is likewise per se known. Such an configuration makes possible a rotation of the handpiece 1 even beyond 360°, whereby a continuous passage is ensured in the media line 5. In similar manner a continuous line passage for the current supply and for the at least one signal line 42 can be realized with a slip ring and an associated slip contact in the region of the hollow cylindrical dividing joint.

For the drive of a moveable, for example rotatable, tool 45 there may serve a turbine arranged in the forward end region of the handpiece 49, which turbine is driven by means of compressed air, which is delivered in a particular pressure line. In the case of a plug-in/turn coupling 56 this pressure line passes through the hollow cylindrical dividing joint of the coupling likewise in a Z-form in the above-described manner.

The tool 45 may also be driveable by means of a drive shaft rotatably mounted in the handpiece 1, which has in its rearward end region a coupling element which upon connection of the handpiece 1 with the connection part at the same time is connected with a counter-coupling element which is driveable by means of a drive motor arranged in the drive part, in particular an electric motor. Such a drive is also known per se and thus does not need to be described in more detail.

With its individual parts, the handpiece 1 is in each case of corrosion resistant material, which is also not sensitive to disinfection or sterilization mediums and for example also an appropriate disinfection or sterilization temperature. Thereby, the parts may be of corrosion resistant metal, in particular alloy steel, or plastics, whereby a working handpiece is preferably of metal and a functional or probe handpiece is preferably of plastics.

The display views in accordance with FIGS. 5 to 7 show work-relevant data or images of the associated handpiece 1 or of the treatment site 14. In FIG. 5 there is provided a display of the speed of rotation, for example a numerical display of revolutions per unit time. Instead or additionally to this speed of rotation display there can also be provided a direction of rotation display, see the illustrated arrow.

FIG. 6 shows an exemplary embodiment for the display of the curve of a diagram, whereby the curve may for example reproduce the respectively available power.

FIG. 7 shows an image of the treatment site 14, here of at least one tooth 15, whereby the person carrying out the treatment can recognize the desired treatment site, for example a cavity. This image is preferably so large that not only the tooth 15 to be treated is shown but also in part its neighbouring teeth.

It is also possible within the scope of the invention, and taking into account a construction for the handpiece 1 which is as small as possible and the restricted space availability connected therewith, advantageously to transmit the data to be shown on the display 21 in a wireless manner. For this purpose there is associated with the handpiece 1a data receiver 61 for wireless data transmission and a data converter device 62 which converts the transmitted data into data which can be shown on the display 21. There can be transmitted to the data receiver 61 work-relevant data from a supply device on the associated treatment chair. There may however also be involved image data which is transmitted from a data transmitter 63 of the image converter device 36 wirelessly to the data receiver 61 to be shown on the display 21.

Independently thereof, the handpiece 1 may also be so constituted that the data of the data transmitter 63 can be transmitted wirelessly to a data receiver belonging to the screen 41 and be shown on the screen 41.

Such a configuration making possible wireless data transmission is possible and advantageous with all exemplary embodiments.

1. Medical or dental medical handpiece, comprising a display for showing work-relevant data or images.

2. Handpiece according to claim 1, wherein the handpiece is of rod-like form and has a forward end and the display has a longitudinally directed spacing from the forward end.

3. Handpiece according to claim 2, wherein the handpiece comprises a grip section extending rearwardly of the display.

4. Handpiece according to claim 1, wherein the handpiece comprises a forward longitudinal region that is angled or curved to a side.

5. Handpiece according to claim 4, wherein the display is arranged in a longitudinal region which extends approximately from a forward end region of the grip section up to approximately a middle region of the angling or curvature of the forward longitudinal region.

6. Handpiece according to claim 4, wherein the display is arranged on a side of the handpiece which is opposed to a direction of angling or the direction of curvature of the forward longitudinal region.

7. Handpiece according to claim 1, wherein the display is arranged on a surface of the handpiece or projects outwardly beyond the surface.

8. Handpiece according to claim 1, comprising at least one actuating element for switching on and switching off the showing of data or images on the display.

9. Handpiece according to claim 8, wherein the actuating element is arranged in an edge region of the display.

10. Handpiece according to claim 8, comprising at least one of an actuating element with which a still image can be switched on or switched off on the display and an actuating element with which an image reproduction on a monitor associated with a treatment station with which the handpiece is used can be switched on or switched off.

11. Handpiece in particular according to claim 1, comprising a forward end region with an image-taking device the images from which can be shown on the display.

12. Handpiece according to claim 11, wherein the image-taking device comprises a light inlet opening which is covered by a light permeable closure plate.

13. Handpiece according to claim 11, wherein the image-taking device comprises a camera module.

14. Handpiece according to claim 11, wherein the image-taking device is arranged off center in an edge region of the handpiece.

15. Handpiece according to claim 11, wherein the image-taking device is arranged in an angling or curvature plane of the handpiece.

16. Handpiece according to claim 11, wherein the image-taking device is arranged in a material annex.

17. Handpiece according to claim 1, wherein the handpiece is at least one of a functional handpiece, a probe handpiece, and a working handpiece.

18. Handpiece according to claim 11, wherein the handpiece comprises an outlet nozzle and the image-taking device is spaced from a forward end of the outlet nozzle less than 30 mm.

19. Handpiece according to claim 11, comprising a working handpiece having an insertion opening for a tool open to a side in a head of the handpiece, wherein the image-taking device is arranged in an end region of the handpiece before or behind the head on a side of the handpiece on which the insertion opening is located, and is directed obliquely towards a middle axis of the insertion opening.

20. Handpiece according to claim 11, comprising a working handpiece having a forwardly open insertion opening for a tool, wherein the image-taking device is arranged in a forward end region of the handpiece.

21. Handpiece according to claim 1, comprising a data receiver, for the reception of wireless transmitted data, associated with the display, which data corresponds to work-relevant data or images which can be shown on the display.

22. Handpiece according to claim 11, comprising a data transmitter, for the transmission of data corresponding to images taken, associated with the image-taking device.

23. Handpiece according to claim 2, wherein the spacing is 20 mm to 80 mm.

24. Handpiece according to claim 23, wherein the spacing is 30 mm to 50 mm.

25. Handpiece according to claim 3, wherein the grip section extends straight rearwardly from the display.

26. Handpiece according to claim 7, wherein the display projects beyond the surface and extends approximately parallel thereto.

27. Handpiece according to claim 7, wherein the display projects beyond the surface and defines with the surface a forwardly open acute angle.

28. Handpiece according to claim 9, wherein the actuating element is arranged in at least one of a rearward edge region or a forward edge region of the display.

29. Handpiece according to claim 15, wherein the image-taking device is arranged on a forwardly directed side of the angling or curvature.

30. Handpiece according to claim 16, wherein the material annex is arranged to a side of the handpiece.

31. Handpiece according to claim 18, wherein the image-taking device is spaced at 5 mm to about 10 mm from the forward end of the outlet nozzle.

32. Handpiece according to claim 20, wherein the image-taking device is arranged in a side periphery region of the handpiece and is forwardly directed.
